(19) United States
(12) Patent Application Publication
(10) Pub. No.: US 2009/0163635 A1
(43) Pub. Date: Jun. 25, 2009

(54) AQUEOUS DISPERSIONS OF ADHESION PROMOTERS

(75) Inventors: Peter Webb Raynolds, Kingsport, TN (US); James A. Stykes, Jonesborough, TN (US)

Correspondence Address: TAMMYE TAYLOR, EASTMAN CHEMICAL COMPANY, 100 N. EASTMAN RD., KINGSPORT, TN, 37660-5075, US

(73) Assignee: EASTMAN CHEMICAL COMPANY, Kingsport, TN (US)

(21) Appl. No.: 11/959,564

(22) Filed: Dec. 19, 2007

(51) Int. Cl. C08K 5/05; C08K 3/00; C08F 261/02

(52) U.S. Cl. 524/385; 524/529; 524/533; 524/535; 524/536

(57) ABSTRACT

Aqueous dispersions of water-insoluble polyolefin-based adhesion promoters are formed by dissolving the adhesion promoter in at least one olefinically unsaturated monomer, forming a mini-emulsion with high shear in the presence of water, surfactant and other additives, and then polymerizing the monomer with a monomer-soluble, substantially water insoluble radical initiator. The polymerized product, a stable dispersion (latex) of polyolefin adhesion promoter and polymerized monomer in water, is useful as a primer or as an additive for improving the adhesion of coatings to polyolefin substrates.

### FIELD OF THE INVENTION

This invention relates to the field of coating compositions, and in particular, to compositions useful as adhesion promoting primers or additives.

### BACKGROUND OF THE INVENTION

Molded plastic parts are widely used in automobiles, trucks, household appliances, graphic arts, and the like. Frequently these plastic parts are made from polyolefins such as polyethylene, ethylene copolymers, polypropylene, propylene copolymers, and polyolefin blends with other polymers. One such blend is a thermoplastic polyolefin (TPO), which is a rubber-modified polypropylene. Frequently, these plastic parts must be painted to match the color of painted metal parts that are also present in the automobile, appliance, or other item. Typical paints do not adhere well to these plastic parts. Thus, adhesion-promoting primers are needed to improve the adhesion of the paints to the polyolefin materials.

Although chlorinated polyolefins, particularly chlorinated, maleated crystalline polypropylene polymers, are effective for this purpose, they have very limited solubility in anything other than aromatic or chlorinated solvents. It is possible to improve the solubility of chlorinated polyolefins in various solvents by increasing the chlorine content of the chlorinated polyolefin. However, increasing the chlorine content of chlorinated polyolefins often results in poor coating adhesion, especially after exposure to humidity and gasoline. In general, a chlorine content of greater than 24 weight percent can result in poor adhesion after exposure to humidity and gasoline.

Attempts have been made to provide water-based paints and primers for the automotive and appliance industries, but these systems generally are not thought to be as effective as solvent-based systems. Thus there remains a need in the art to provide polyolefin-based adhesion promoters in waterborne systems

### SUMMARY OF THE INVENTION

Aqueous dispersions of water-insoluble polyolefin-based adhesion promoters are formed by dissolving the adhesion promoter in at least one ethylenically unsaturated monomer, forming a mini-emulsion with high shear in the presence of water, surfactant and optionally other additives, and then polymerizing the monomer with a radical initiator. The polymerized product, a stable dispersion (latex) of polyolefin adhesion promoter and polymerized monomer in water, is useful as a primer or as an additive for improving the adhesion of coatings to polyolefin substrates.

### DETAILED DESCRIPTION OF THE INVENTION

Before the present compositions of matter and methods are disclosed and described, it is to be understood that this invention is not limited to specific methods or to particular formulations, except as indicated, and as such, may vary from the disclosure. It is also to be understood that the terminology used is for the purpose of describing particular embodiments only, and is not intended to limit the scope of the invention.

The singular forms “a,” “an,” and “the” include plural referents, unless the context clearly dictates otherwise.

Optional or optionally means that the subsequently described event or circumstances may or may not occur. The description includes instances where the event or circumstance occurs, and instances where it does not occur.

Ranges may be expressed herein as from about one particular value, and/or to about another particular value. When such a range is expressed, it is to be understood that another embodiment is from the one particular value and/or to the other particular value, along with all combinations within said range.

Throughout this application, where patents or publications are referenced, the disclosures of these references in their entireties are intended to be incorporated by reference into this application, in order to more fully describe the state of the art to which the invention pertains, except when these reference contradict the statements made herein.

As used herein, the term “olefin” means unsaturated aliphatic hydrocarbons having one or more double bonds, such as obtained by cracking petroleum fractions.

Specific examples of olefins include, but are not limited to, propylene, 1-butene, 1,3-butadiene, isobutylene and diisobutylene. A “polyolefin” is a polymer formed from olefins. Common examples are polypropylene and polybutylene and include the class of thermoplastic polyolefins (TPOs). The polyolefin may be homopolymeric or copolymeric. A variety of homopolymeric halogenated polyolefins are available from Eastman Chemical Company, among others. A halogenated polyolefin is a halogen-substituted polyolefin, and is typically chlorinated or brominated.

As used herein, the term “polymer(s)” includes homopolymers, copolymers, and/or terpolymers.

In one embodiment of the present invention, aqueous dispersions of water-insoluble polyolefin-based adhesion promoters are formed by dissolving at least one adhesion promoter in at least one ethylenically unsaturated monomer, forming a mini-emulsion with high shear in the presence of water, surfactant(s) and optionally other additives, and then polymerizing the monomer with a radical initiator, suitably a monomer-soluble, substantially water insoluble radical initiator. The polymerized product, a stable dispersion (latex) of polyolefin adhesion promoter and polymerized monomer in water, is useful as a primer or as an additive for improving the adhesion of coatings to polyolefin substrates.

In one embodiment of the present invention, a process to produce an aqueous composition is provided. The process comprises shearing a mixture to produce a mini-emulsion and polymerizing the mini-emulsion in the presence of an initiator to produce an aqueous composition. The mixture comprises at least one adhesion promoter, at least one ethylenically unsaturated monomer, and at least one surfactant and water.

As used herein, mini-emulsion polymerization refers to a process in which a polymer, and especially a polyolefin polymer, is dissolved in one or more monomers having ethylenic unsaturation to obtain a polyolefin/monomer mixture; the polyolefin/monomer mixture is dispersed in an aqueous medium to form a pre-emulsion; the pre-emulsion is subjected to high stress techniques to form small droplets having an average particle size from about 25 to about 500 nm, known herein as a mini-emulsion; and the mini-emulsion is then polymerized via free radical emulsion polymerization to obtain an acrylic/polyolefin hybrid latex polymer that is useful as a waterborne adhesion promoter.

In one aspect, the invention relates to a waterborne modified polyolefin polymer, described herein as a hybrid latex, made via a mini-emulsion polymerization. The hybrid latex results from the polymerization of a mini-emulsion of at least one ethylenically unsaturated monomer having dissolved therein at least one polyolefin adhesion promoter.

In the waterborne latexes of the invention, the hybrid latex generally exists as particles dispersed in water. The particles may be generally spherical in shape. The particles may be structured or unstructured. Structured particles include, but are not limited to, core/shell particles and gradient particles. The core/shell polymer particles may also be prepared in a multi-lobe form, a peanut shell, an acorn form, or a raspberry form. The core portion may comprise, for example, from about 20 to about 80 weight percent of the total weight of the particle, and the shell portion may comprise from about 80 to about 20 weight percent of the total weight of the particle. The average particle size of the hybrid latex may range from about 25 to about 500 nm, or from about 50 to about 400 nm, or from about 100 to about 300 nm.

The glass transition temperature (T_{g}) of the acrylic portion of the hybrid resin in accordance with the invention may be up to about 100° C. The glass transition temperature is preferably under 70° C. where film formation of the latex at ambient temperature is desirable, or from about 20° to about 50° C.

In one aspect, the invention provides a latex composition prepared by the steps of

(a) dissolving at least one adhesion promoter in one or more ethylenically unsaturated monomers to obtain a polyolefin/monomer mixture;

(b) dispersing the adhesion promoter/monomer mixture in an aqueous medium to form a pre-emulsion; applying shear to the pre-emulsion to obtain a mini-emulsion having an average particle size from about 25 nm to about 500 nm; and

(c) emulsion polymerizing the mini-emulsion via free radical polymerization.

In one embodiment, the adhesion promoter is a polyolefin adhesion promoter such as a commercially available halogenated and/or maleated adhesion promoters from Eastman Chemical Company, for example, Eastman's 343-1 and 730-1 or maleated polyolefins (unchlorinated) such as Eastman's 440-1.

In one embodiment, the polyolefin adhesion promoters may be prepared by reacting polyolefins with unsaturated carboxylic esters, unsaturated carboxylic acids, unsaturated carboxylic anhydrides, vinyl monomers, acrylic monomers, or mixtures thereof. The carboxylated polyolefins are then chlorinated by reaction with at least one chlorinating agent. The chlorinating agent can be any known in the art capable of chlorinating polyolefins. However, the order of these two steps is not critical to the invention. Chlorinated carboxylated polyolefins useful in this invention can also be prepared by chlorinating the polyolefin prior to the introduction of the carboxyl-containing compounds. The chlorinated carboxylated polyolefins may be further modified by reaction with one or more polyfunctional alcohols.

In one embodiment, the chlorinated carboxylated polyolefin is further reacted with one or more polyfunctional alcohols. Suitable alcohols will have at least two hydroxyl groups or at least one hydroxyl group and another functional group capable of preferentially reacting with the chlorinated carboxylated polyolefin. Such preferentially reactive functional groups include amino, epoxy, and the like. In one embodiment of the invention, at least one hydroxyl group of the polyfunctional alcohol remains essentially unreacted with the chlorinated carboxylated polyolefin.

Exemplary polyfunctional alcohols include, but are not limited to, trimethylolethane, pentaerythritol, trimethylolpropane, 1,6-hexanediol, 1,4-cyclohexanediol, 1,2-propylene glycol, 1,3-propylene glycol, neopentyl glycol, 1,4-cyclohexanedimethanol, 2,2,4-trimethyl-1,3-pentanediol, 2-ethyl-1,3-hexanediol, 2-butyl-2-ethyl-1,3-propanediol, 2,2-dibutyl-1,3-propanediol, 2-methyl-2-propyl-1,3-propanediol, 2,2-diethyl-1,3-propanediol, ethylene glycol, diethylene glycol, triethylene glycol, polyethylene glycols, glycerol, polyester polyols, acrylic polyols, polyurethanepolyols, glucose, sucrose, 2-amino-1-propanol, ethanolamine, 2-amino-2-methyl-1-propanol, tris(hydroxymethyl)methylamine, 2,2-dimethyl-3-amino-1-propanol, and the like. In one embodiment, the polyfunctional alcohol is selected from a group comprising 2-ethyl-1,3-hexanediol, 2,2,4-trimethyl-1,3-pentanediol, 2-butyl-2-ethyl-1,3-propanediol, neopentyl glycol, and 1,6-hexanediol. Especially preferred are those polyfunctional alcohols having one primary hydroxyl group, and one secondary or tertiary hydroxyl group and polyfunctional alcohols based on 1,3-propanediol which are doubly substituted at the middle carbon position (C-2). These especially preferred polyfunctional alcohols include, but are not limited to, 2-ethyl-1,3-hexanediol, 2,2,4-trimethyl-1,3-pentanediol, 1,2-propylene glycol, neopentyl glycol, 2-butyl-2-ethyl-1,3-propanediol, 2,2-dibutyl-1,3-propanediol, 2,2-diethyl-1,3-propanediol, and 2-methyl-2-propyl-1,3-propanediol. The amount of polyol used to modify the chlorinated carboxylated polyolefin will generally be in the range of about 0.01 to about 60 weight percent, based on the weight of the chlorinated carboxylated polyolefin.

The polyolefins useful as starting materials in the present invention include ethylene copolymers prepared from ethylene and alpha olefins having 3 to about 10 carbon atoms, polypropylene, propylene copolymers prepared from ethylene or alpha olefins having from 4 to about 10 carbon atoms, poly(1-butene), 1-butene copolymers prepared from ethylene or alpha olefins having 3 to about 10 carbon atoms, propylene terpolymers prepared from ethylene and/or alpha olefins having from 4 to about 10 carbon atoms, and the like. In addition, mixtures of the previously mentioned polyolefins may be used in this process, as opposed to using a single polyolefin.

Examples of methods to produce polyolefin adhesion promoters suitable for use in the present invention are found in US 2006/0074181 which is incorporated herein by reference.

In one embodiment, the polyolefin adhesion promoter is present in the latex in an amount from about 0.5 to about 60 weight percent based on the total solids of the aqueous composition, for example, from about 5 to about 40 weight percent, or from about 10 to about 30 weight percent. The weight percent is the weight of adhesion promoter divided by the sum of the weights of adhesion promoter and monomer, times 100%.

In one embodiment, the ethylenic unsaturated monomers are selected from one or more ethylenically unsaturated monomers. Examples of suitable ethylenically unsaturated monomers include, but are not limited to, styrenic monomers such as styrene, .alpha.-methyl styrene, vinyl naphthalene, vinyl toluene, chloromethyl styrene and the like; ethylenically unsaturated species such as, for example, methyl acrylate, acrylic acid, methacrylic acid, methyl methacrylate, ethyl acrylate, ethyl methacrylate, butyl acrylate, butyl methacrylate, isobutyl acrylate, isobutyl methacrylate, ethylhexyl acrylate, ethylhexyl methacrylate, octyl acrylate, octyl methacrylate, lauryl methacrylate, lauryl acrylate glycidyl methacrylate, carbodiimide methacrylate, alkyl crotonates, vinyl acetate, di-n-butyl maleate, di-octylmaleate, acetoacetoxyethyl methacrylate, diacetone acrylamide, acrylamide, methacrylamide, hydroxyethyl methacrylate, hydroxyethyl acrylate, and acrylonitrile and the like; or nitrogen containing monomers including t-butylaminoethyl methacrylate, dimethylaminoethyl methacrylate, diethylaminoethyl methacrylate, N,N′-dimethylaminopropyl methacrylamide, 2-t-butylaminoethyl methacrylate, N,N′-dimethylaminoethyl acrylate, N-(2-methacryloyloxy-ethyl)ethylene urea, methacrylamidoethylethylene urea and the like.

In one embodiment, an additional co-monomer optionally may be included in the polymerization. Suitably, this co-monomer may be any pendant moiety which is capable of (i) surviving the polymerization process and (ii) participating in or promoting crosslinking of the monomer resin. Further, this co-monomer should be capable of participating in or promoting oxidative crosslinking. For example, a latent oxidatively-functional (LOF) acrylic monomer may be used if it provides a source of free radicals to generate a free-radical flux. The LOF group of the co-monomer also may have an ethylenic unsaturation such as, but not limited to, allyl and vinyl groups. The LOF group of the co-monomer also may be an acetoacetoxy moiety or enamine moiety. Preparation of enamines from acetoacetyl groups are described in U.S. Pat. Nos. 5,296,530, 5,494,975, and 5,525,662 which are incorporated herein by reference. Suitable acrylic co-monomers having latent oxidatively-functional (LOF) groups include, but are not limited to, allyl methacrylate, vinyl methacrylate, acetoacetoxyethyl methacrylate, hydroxybutenyl methacrylate, the allyl or diallyl ester of maleic acid, poly(allyl glycidyl ether), or mixtures thereof.

Suitably, the LOF acrylic monomer is added as a mixture of at least one LOF acrylic monomer and an ethylenically unsaturated co-monomer. Typical monomers may be found in U.S. Pat. Nos. 6,333,378; 6,01,922; 5,869,590; and 5,539,73, incorporated herein by reference. Polyfunctional or crosslinking monomers such as di- and tri(meth)acrylates; allyl methacrylate may also be utilized.

In one embodiment, the invention utilizes water-soluble monomers like (meth)acrylic acid and hydroxyethyl or hydroxypropyl (meth)acrylate, along with relatively water insoluble monomers exemplified by styrene, butyl (meth)acrylate, 2-ethylhexyl (meth)acrylate, stearoyl (meth)acrylate, dodecyl (meth)acrylate.

In another embodiment, the invention utilizes (meth)acrylic acid at less than 5% of the total monomer weight; hydroxyethyl (meth)acrylate at less than 20% of the total monomer weight; combinations of butyl methacrylate, 2-ethylhexyl (meth)acrylate and styrene to give the desired Tg at greater than 75%. By (meth)acrylate we mean either the methacrylate or the acrylate ester.

Additionally, according to the mini-emulsion polymerization process of the present invention, the polyolefin/monomer mixture may further comprise one or more optional polymeric or water-insoluble, higher-molecular-weight substances such as polymers selected from polystyrene, polyurethane, polyester, cellulose esters, and alkyds. Such additional materials may be present in amounts of from 0 to about 1 weight percent.

Optionally, in one embodiment of the present invention, a surfactant may be added to the aqueous phase, as a stabilizer, during the polymerization of the mini-emulsion. Typically, the surfactant provides droplet/particle stability, but results in minimal aqueous phase nucleation (micellar or homogeneous). The surfactant can be any conventional surfactant or a combination of surfactants known in the art. Examples of suitable surfactants include, but are not limited to, alkali alkylsulfate, ammonium alkylsulfate, alkylsulfonic acid, fatty acid, oxyethylated alkylphenol, sodium dodecyl sulfate, sulfosuccinates and derivatives, or any combination of anionic or non-ionic surfactants. In one embodiment, the surfactant is an anionic surfactant. In another embodiment, the surfactant is a polymerizable surfactant such as Hitenol 20. In yet a further embodiment, the surfactant is selected from sodium dodecyl sulfate and sodium bis(2-ethylhexyl) sulfosuccinate (Aerosol OT-75). A further list of suitable surfactants is available in the treatise: McCutcheon's Emulsifiers & Detergents, North American Edition, MC Publishing Co., Glen Rock, N.J., 1997. In one embodiment, the surfactant may be present in an amount from about 0.1 to about 10% by weight and in another embodiment from about 0.3% to about 3% by weight based on the total solids of the composition.

The mini-emulsion polymerization process by which the hybrid latexes are made may also require an initiator, a reducing agent, or a catalyst. Suitable initiators include conventional initiators such as t-butylperoxy 2-ethylhexanoate, azo initiators such as AIBN, or ammonium persulfate, ammonium carbonate, hydrogen peroxide, t-butylhydroperoxide, ammonium or alkali sulfate, di-benzoyl peroxide, lauryl peroxide, di-t-butylperoxide, 2,2′-azobisisobutyronitrile, benzoyl peroxide, and the like. Suitably, the polymerization initiator may be either water soluble or monomer soluble. However, better adhesion performance may be achieved with monomer soluble initiators. For example, in one embodiment, the initiator is one that is soluble in the monomer mixture and relatively insoluble in water. Examples of such monomer-soluble initiators include t-butylperoxy 2-ethylhexanoate and azo initiators such as AIBN, present in an amount of about 0.1% to about 6% by weight or about 0.3% to about 3% by weight based on the total solids of the composition. If the initiator is added directly to the monomer, it can be completely insoluble in water. If the monomer-soluble initiator is added to the aqueous reaction mixture, a small amount of water solubility (<about 1%) may be needed for the initiator to transfer through the water to the miniemulsion droplet.

Suitable reducing agents are those which increase the rate of polymerization and include, for example, sodium bisulfite, sodium hydrosulfite, sodium formaldehyde sulfoxylate, ascorbic acid, isoascorbic acid, and mixtures thereof.

Suitable catalysts are those compounds which promote decomposition of the polymerization initiator under the polymerization reaction conditions thereby increasing the rate of polymerization. Suitable catalysts include transition metal compounds and driers. Examples of such catalysts include, but are not limited to, ferrous sulfate heptahydrate, ferrous chloride, cupric sulfate, cupric chloride, cobalt acetate, cobaltous sulfate, and mixtures thereof.

In another embodiment of the present invention, an additional polymer or hydrophobic component optionally may be added in the polymerization process. Any polymer or hydrophobic component that is soluble in one or more of the ethylenically unsaturated monomer(s) or mixture of monomers used in the polymerization would be suitable. Suitably, the polymer or hydrophobic material should have a weight average molecular weight of 3000 or greater to provide efficient droplet stabilization. For example, polymers or mixtures of polymers such as, but not limited to, poly(methyl methacrylates), polystyrenes, polyvinyl acetates, or alkyds suitably may be used. This polymer or hydrophobic component may be added in an amount of about 0.5 to about 60 weight percent based on the weight of the monomer. Typically, about 0.5 to about 5.0 weight percent of this polymer or hydrophobic component is required to provide droplet stabilization. However, the amount of hydrophobic component added can be determined based on the properties desired in the final product.

The adhesion promoter, ethylenically unsaturated monomer, water, as well as the optional surfactant or optional hydrophobic component can be combined in any order to make the pre-emulsion. However, all of these components should be present prior to shearing.

In another embodiment, the emulsion polymerization may take place in the presence of optional co-stabilizers such as water insoluble, low molecular weight compounds such as hexadecane and hexadecanol in amounts from 0 to about 6 weight percent based on the total solids of the composition.

In another embodiment, the waterborne adhesion promoter composition may further comprise acids and bases to adjust pH; biocides; antifoams; antistats; viscosity modifiers; coalescents; stabilizers typically used to stabilize CPOs; chain transfer agents to modify molecular weight, especially mercaptans, in amounts from 0 to about 10 weight percent based on the totals solids of the composition.

The miniemulsion polymerization process differs from an emulsion polymerization chiefly in the high shear applied to the monomer-water-surfactant emulsion prior to polymerization. According to the invention, stress or shear is applied to a mixture of surfactant, polyolefin, one or more monomers, and water, by high stress techniques, to form the mini-emulsion. High stress techniques refer to techniques suitable to obtain droplets or particles having an average particle size of from about 25 nm to about 500 nm, or from about 50 to about 400 nm, or from about 100 to about 300 nm.

One method of providing high shear to form the particles is to use a MICROFLUIDIZER® emulsifier, available from Microfluidics Corporation in Newton, Mass. The device consists of a high pressure (up to 25,000 psi) pump and an interaction chamber where the emulsification takes place. Generally, the reaction mixture is passed through the emulsifier at least once, at a pressure between 5,000 and 15,000 psi. Multiple passes may be used to achieve a smaller average particle size or a narrower range of particle size distribution.

Stress may be described as force per unit area. Although the mechanism by which an emulsifier stresses a pre-emulsification mixture is not well understood, it is possible that stress is exerted in more than one manner. One manner in which stress is believed to be exerted is by shear, meaning that the force is such that one layer or plane moves parallel to an adjacent, parallel plane. Stress can also be exerted from all sides, as a bulk, compression stress. In such cases, stress can be exerted without any shear. A further manner of producing intense stress is by cavitation, which occurs when the pressure within a liquid is reduced enough to cause vaporization. The formation and collapse of the vapor bubbles occurs violently over a short period of time, producing intense stress. Although not intending to be bound by theory, it is possible that both shear and cavitation contribute to producing the stress which particulates the pre-emulsification mixture in such instances. As used herein, the term stress is intended to include any manner by which the desired mini-emulsion is achieved.

Another way to obtain high shear in order to form a mini-emulsion is by the use of ultrasonic energy or sonication, for example with a Fisher 300 Watt Sonic dismembrator for about 5 minutes at about a 60 percent output (180 watts), with bulk mixing provided by a stirring bar. (The Fisher 300 Watt Sonic dismembrator is manufactured and distributed by Fisher Scientific Company, Pittsburgh, Pa.) Other high shear mixing equipment, e.g., a colloid mill or homogenizer, can be used if desired. (The sonic dismembrator herein described is suitable for laboratory scale. A colloid mill or homogenizer are suitable for production scale.) In general, any equipment capable of producing localized high shear along with moderate bulk mixing can be used.

Thus, under mini-emulsion polymerization conditions, as used herein, a polyolefin is dissolved in at least one ethylenically unsaturated monomer, each as described herein. According to the invention, the polyolefin is considered “dissolved” or soluble in the monomer if, after addition of the polyolefin, a clear to slightly turbid solution mixture forms with no apparent phase separation upon standing (i.e. the solution appears substantially homogeneous). The resulting mixture is then dispersed in an aqueous medium to form a pre-emulsion. The aqueous medium may be any aqueous medium known in the art used in such polymerization conditions such as, for example, a water/surfactant solution. Examples of suitable surfactants include, but are not limited to, sodium dodecyl sulfate, TERGITOL 15S-40, AEROSOL OT-NV, and DOWFAX 2A1. Polymerizable surfactants may also be used. The pre-emulsion is then stressed or sheared using a high-shear device to form a mini-emulsion. Shearing the emulsion to form small droplets prior to polymerization is believed to cause the predominant nucleation site and subsequent polymerization to occur within the droplets. As a result, transport of the monomer from the droplets and precipitation of the solvent-borne polyolefin is believed to be avoided. Droplets of the mini-emulsion typically range in size from about 25 to about 500 nm. The mini-emulsion may then be polymerized, as with conventional emulsion polymerization techniques for forming acrylic latexes.

Alternative modes of applying stress to the pre-emulsification mixture can be used, so long as sufficient stress is applied to achieve the requisite particle size distribution. For purposes of the present invention, the average droplet or particle size is typically from about 25 to about 500 nm, or from about 50 nm to about 400 nm, or from about 100 to about 300 nm. After polymerization, it is preferred that less than 20% of the polymer droplets or particles have a mean diameter greater than about 300 nm.

As noted above, these polyolefins are especially useful as primers for coating substrates which suffer from poor paint adhesion. Accordingly, such resins may be applied to, for example, a plastic substrate, allowed to dry, and a conventional topcoat coating composition applied thereto. Alternatively, the compositions of the invention may be blended with various coating compositions to afford a self-priming composition useful for coating such substrates. In this regard, such topcoat compositions may be any coating composition, typically comprised of any number of traditional resins, for example, polyesters, acrylics, urethanes, melamines, alkyds, etc. In addition, such compositions may also further comprise one or more typical coatings additives. Thus, as a further aspect of the present invention there is provided a coating composition comprising the hybrid latexes of the present invention, further comprising one or more coatings additives such as leveling, rheology, and flow control agents such as silicones, fluorocarbons or cellulosics; neutralized carboxylic acid-containing latex particles with highly crosslinked particles; associative thickeners; flatting agents; pigment wetting and dispersing agents and surfactants; ultraviolet (UV) absorbers; UV light stabilizers; tinting pigments; defoaming and antifoaming agents; anti-settling, anti-sag, and bodying agents; anti-skinning agents; anti-flooding and anti-floating agents; fungicides and mildewcides; corrosion inhibitors; thickening agents; or coalescing agents. Specific examples of such additives can be found in Raw Materials Index, published by the National Paint & Coatings Association, 1500 Rhode Island Avenue, N.W., Washington, D.C. 20005.

Examples of flatting agents include synthetic silica, available from the Davison Chemical Division of W. R. Grace & Company under the trademark SYLOID®; polypropylene, available from Hercules Inc., under the trademark HERCOFLAT®; and synthetic silicate, available from J. M. Huber Corporation under the trademark ZEOLEX®.

Examples of dispersing agents and surfactants include sodium bis(tridecyl) sulfosuccinate, di(2-ethylhexyl) sodium sulfosuccinate, sodium dihexylsulfosuccinate, sodium dicyclohexyl sulfosuccinate, diamyl sodium sulfosuccinate, sodium diisobutyl sulfosuccinate, disodium iso-decyl sulfosuccinate, disodium ethoxylated alcohol half ester of sulfosuccinic acid, disodium alkyl amido polyethoxy sulfosuccinate, tetrasodium N-(1,2-dicarboxy-ethyl)-N-octadecyl sulfosuccinamate, disodium N-octasulfosuccinamate, sulfated ethoxylated nonylphenol, 2-amino-2-methyl-1-propanol, and the like.

Examples of viscosity, suspension, and flow control agents include polyaminoamide phosphate, high molecular weight carboxylic acid salts of polyamine amides, and alkylene amine salts of an unsaturated fatty acid, all available from BYK Chemie U.S.A. under the trademark ANTI TERRA®. Further examples include polysiloxane copolymers, polyacrylate solution, cellulose esters, hydroxyethyl cellulose, hydrophobically-modified hydroxyethyl cellulose, hydroxypropyl cellulose, polyamide wax, polyolefin wax, carboxymethyl cellulose, ammonium polyacrylate, sodium polyacrylate, and polyethylene oxide. Other examples of thickeners include the methane/ethylene oxide associative thickeners and water soluble carboxylated thickeners, for example, those sold under the UCAR POLYPHOBE trademark by Union Carbide.

Several proprietary antifoaming agents are commercially available, for example, under the trademark BRUBREAK of Buckman Laboratories Inc., under the BYK® trademark of BYK Chemie, U.S.A., under the FOAMASTER® and NOPCO®. trademark of Henkel Corp./Coating Chemicals, under the DREWPLUS® trademark of the Drew Industrial Division of Ashland Chemical Company, under the TROYSOL® and TROYKYD® trademarks of Troy Chemical Corporation, and under the SAG® trademark of Union Carbide Corporation.

Examples of fungicides, mildewcides, and biocides include 4,4-dimethyloxazolidine, 3,4,4-trimethyloxazolidine, modified barium metaborate, potassium N-hydroxy-methyl-N-methyldithiocarbamate, 2-(thiocyanomethylthio) benzothiazole, potassium dimethyl dithiocarbamate, adamantane, N-(trichloromethylthio) phthalimide, 2,4,5,6-tetrachloroisophthalonitrile, orthophenyl phenol, 2,4,5-trichlorophenol, dehydroacetic acid, copper naphthenate, copper octoate, organic arsenic compounds, tributyl tin oxide, zinc naphthenate, and copper 8-quinolinate.

Examples of U.V. absorbers and U.V. light stabilizers include substituted benzophenones, substituted benzotriazoles, hindered amines, and hindered benzoates, available from American Cyanamid Company under the trademark CYASORB UV, and diethyl-3-acetyl-4-hydroxy-benzyl-phosphonate, 4-dodecyloxy-2-hydroxy benzophenone, and resorcinol monobenzoate.

Such paint or coating additives as described above form a relatively minor proportion of the coating composition, for example, from about 0.05 to about 5.00 weight percent based on the total weight of the components of the composition.

As a further aspect of the present invention, there is provided a coating composition as set forth above, further comprising one or more pigments and/or fillers in a concentration of about 1 to about 70 weight percent, for example from about 30 to about 60 weight percent, based on the total weight of the components of the composition.

Pigments suitable for use in the coating compositions envisioned by the present invention are the typical organic and inorganic pigments, well-known to one of ordinary skill in the art of surface coatings, especially those set forth by the Colour Index, 3d Ed., 2d Rev., 1982, published by the Society of Dyers and Colourists in association with the American Association of Textile Chemists and Colorists. Examples include, but are not limited to the following: CI Pigment White 6 (titanium dioxide); CI Pigment Red 101 (red iron Oxide); CI Pigment Yellow 42, CI Pigment Blue 15, 15:1, 15:2, 15:3, 15:4 (copper phthalocyanines); CI Pigment Red 49:1; and CI Pigment Red 57:1.

One group of surfactants useful in the coating compositions envisioned by the present invention may be broadly described as nonionic surfactants. The surfactants may have a molecular weight of up to 500 or greater and may include polymeric materials. The surfactants include materials that contain groups of varying polarity whereby one part of the molecule is hydrophilic and the other part of the molecule is hydrophobic. Examples of such materials include polyethyleneoxy polyols and ethoxylated alkyl phenols. Particularly preferred classes of surfactants include alkyl phenoxy poly(ethyleneoxy) alcohols, primary ethoxylated alcohols and secondary ethoxylated alcohols. Suitably, the surfactant is a primary ethoxylated alcohol having 12 to 15 carbon atoms or a secondary ethoxylated alcohol having 11 to 15 carbon atoms. Examples of alkyl phenoxy poly(ethyleneoxy) alcohols include IGEPAL® CO-710 sold by Rhone Poulenc. Examples of primary ethoxylated alcohols include NEODOL® 25-9 and NEODOL® 25-12 sold by Shell Chemical Company. Examples of secondary ethoxylated alcohols include TERGITOL® 15-S-9 and TERGITOL® 15-S-15 sold by Union Carbide Company. Suitably, the amount of surfactant is in the range of 0 to 50 weight percent, for example in the range of 0 to 25 weight percent, based on the weight of the modified chlorinated carboxylated polyolefin. Other examples of surfactants include those described in U.S. Pat. No. 5,663,266, incorporated herein by reference.

The amount of water may vary widely and there is no upper limit on the amount of water used. There may be a lower limit on the amount of water because sufficient water should be present in the composition to result in the formation of an admixture of the components. In one embodiment, there is at least 50 weight percent water in the composition, based on the weight of the total composition. In another embodiment, there is about 50 to 90 weight percent of water in the composition.

The compositions of the present invention are useful, for example, in primers for plastic and metal substrates prior to painting. Dispersions of the compositions may be applied to the substrate as prepared, or they may be further diluted with water. Both the water-based materials may be applied to the substrate by spray application, dipping, or any other means available, which allows for a uniform coating of the compositions onto the substrate. Subsequent topcoats, such as paints, adhesives, and inks, can then be applied on top of the primers of the present invention.

If desired, a co-solvent may be utilized in the waterborne coating compositions. In this regard, suitable co-solvents for the water-borne compositions of the present invention include ethanol, n-propanol, isopropanol, n-butanol, sec-butanol, isobutanol, ethylene glycol monobutyl ether, propylene glycol n-butyl ether, propylene glycol methyl ether, propylene glycol monopropyl ether, dipropylene glycol methyl ether, diacetone alcohol, and other water-miscible solvents.

These compositions may also be used as additives for paint topcoats. In this instance, the compositions may be added to the coating prior to application on a substrate.

Such paint or coating additives as described previously form a relatively minor proportion of the coating composition, suitably from about 0.05 to about 5.00 weight percent, based on the total weight of the components of the composition.

As a further aspect of the present invention, there is provided an adhesion-promoting coating composition as set forth previously, further comprising one or more pigments and/or fillers in a concentration of about 0.5 to about 50 weight percent, for example from about 5 to about 30 weight percent, based on the total weight of the components of the composition.

Pigments suitable for use in the coating compositions envisioned by the present invention are the typical organic and inorganic pigments, well-known to one of ordinary skill in the art of surface coatings, especially those set forth by the Colour Index, 3d Ed., 2d Rev., 1982, published by the Society of Dyers and Colourists in association with the American Association of Textile Chemists and Colorists. Examples include, but are not limited to the following: CI Pigment Black 7 (carbon black), CI Pigment White 6 (titanium dioxide); CI Pigment Red 101 (red iron Oxide); CI Pigment Yellow 42, CI Pigment Blue 15, 15:1, 15:2, 15:3, 15:4 (copper phthalocyanines); CI Pigment Red 49:1; and CI Pigment Red 57:1.

The adhesion-promoting coating compositions of the present invention as well as their aforementioned blends with conventional coating formulations to form self-priming compositions may be applied to the substrate by spray application, dipping, or any other means available, which allows for a uniform coating of the adhesion-promoting coating composition onto the reinforced non-olefin substrate.

This invention can be further illustrated by the following examples of preferred embodiments thereof, although it will be understood that these examples are included merely for purposes of illustration and are not intended to limit the scope of the invention.

### EXAMPLES

### Example 1

A solution of 229 g butyl methacrylate, 59 g 2-ethylhexyl acrylate and 126 g CP 343-1 was made at 50-60° C. A solution of 253 g water, 4.2 g sodium dodecyl sulfate, 2.0 g 50% sodium hydroxide, 4.2 g of a 50% solution in water of sodium 2-acrylamido-2-methylpropane sulfonate (Lubrizol 2405-AMPS) and 5.9 g methacrylic acid was put in a jacketed flask, and cold (15° C.) tap water was circulated through the jacket. The water solution was agitated with a mechanical homogenizer (IKA Labortechnik Ultra-Turrax T50 Basic with a recirculating head) as the solution of monomer and CP 343-1 was added to it. A miniemulsion was formed by shearing at a speed setting of 6 (10,000 rpm) for 15 minutes. The pH of the miniemulsion was 5.0 and the particle size (mv) by light scattering (Microtrac) in 0.1% sodium dodecyl sulfate was 498 nm.

Polymerization was carried out in a 1-L jacketed reactor heated with circulating water and equipped with a nitrogen inlet, thermocouple and mechanical agitator. The reactor was charged with 240 g water, purged with nitrogen and heated to 85-90° C. The miniemulsion formed in the prior step was then added over ca 120 minutes. Concurrently, a dispersion of 2.0 g t-butyl peroctoate, 0.5 sodium dodecyl sulfate and 46 g water was added over 120 min. The contents of the reactor was then held at 85-90° C. for one hour, cooled and filtered through a 100 mesh screen. The milky-white, low viscosity product had a pH of 5.8, a particle diameter of 429 nm, 41.7% NVM.

The ability of the product to enhance adhesion was evaluated as in Example 4. The Control sample contains commercial product, CP 310W, without an adhesion promoter. Each percent is the average of three determinations.

One-pack topcoat: The Control sample provides a comparison of Example 1 with a commercial product.

| Adhesion | Initial | 24 hours | 48 | 72 | 168 | 216 |
|---|---|---|---|---|---|---|
| Promoter | Adhesion | humidity | hours | hours | hours | hours |
| None | 0% | — | — | — | — | — |
| Example 1 | 100% | 97% | 99% | 100% | 97% | 93% |
| | | 8D | 8D | 8D | 8D | 8D |
| Control | 100% | 100% | 100% | 100% | 100% | 100% |
| | | 8D | 8D | 8D | 8D | 8D |

Two-pack topcoat: Example 1 performs better than the Control, which typically does not perform well in our evaluations with a two-pack topcoat.

| Adhesion | Initial | 24 hours | 48 | 72 | 168 | 216 |
|---|---|---|---|---|---|---|
| Promoter | Adhesion | humidity | hours | hours | hours | hours |
| None | 0% | — | — | — | — | — |
| Example 1 | 100% | 100% | 100% | 100% | 95% | 100% |
| | | 8D | 8D | 8D | 8D | 8D |
| Control | 100% | 48% | 12% | 9% | 5% | 3% |
| | | 8D | 8D | 8D | 6D | 6D |

### Example 2

### Comparative

General procedure for the preparation of a miniemulsion with a mechanical homogenizer, followed by semi-continuous polymerization using a monomer-soluble initiator.

A solution of 262 g butyl methacrylate, 67 g 2-ethylhexyl acrylate and 84 g CP 730-1 was made at 50-55° C. A solution of 253 g water, 4.2 g sodium dodecyl sulfate, 2.0 g 50% sodium hydroxide, 4.2 g of a 50% solution in water of 2-acrylamido-2-methylpropane sulfonate (Lubrizol 2405-AMPS) and 6.7 g methacrylic acid was put in a jacketed flask, and cold (15° C.) tap water was circulated through the jacket. The water solution was agitated with a mechanical homogenizer (IKA Labortechnik Ultra-Turrax T50 Basic with a recirculating head) as the solution of monomer and CP 730-1 was added to it. A miniemulsion was formed by shearing at a speed setting of 6 (10,000 rpm) for 14 minutes. The pH of the miniemulsion was 5.3 and the particle size (mv) by light scattering (Microtrac) in 0.1% sodium dodecyl sulfate was 422 nm. The miniemulsion was cooled to 20° C. and 2.0 g of t-butyl peroctoate, a monomer-soluble radical initiator, was added, and the miniemulsion was agitated with a turbine blade for 20 minutes as it was kept cold in ice and water.

Polymerization was carried out in a 1-L jacketed reactor heated with circulating water and equipped with a nitrogen inlet, thermocouple and mechanical agitator. The reactor was charged with 240 g water and 4.2 g Lubrizol 2405 AMPS, purged with nitrogen and heated to 85-90° C. The miniemulsion formed in the prior step was added over 93 minutes. The contents of the reactor was then held at 85-90° C. for one hour, cooled and filtered through a 100 mesh screen. The milky-white, low viscosity product had a pH of 5.8, a particle diameter of 382 nm, 43.8% NVM.

### Example 3

### Comparative

Same procedure as Example 2 but made with a water-soluble initiator.

A solution of 262 g butyl methacrylate, 67 g 2-ethylhexyl acrylate and 84 g CP 730-1 was made at 50-55° C. A solution of 253 g water, 4.2 g sodium dodecyl sulfate, 2.0 g 50% sodium hydroxide, 4.2 g of a 50% solution in water of 2-acrylamido-2-methylpropane sulfonate (Lubrizol 2405-AMPS) and 6.7 g methacrylic acid was put in a jacketed flask, and cold (150) tap water was circulated through the jacket. The water solution was agitated with a mechanical homogenizer (IKA Labortechnik Ultra-Turrax T50 Basic with a recirculating head) as the solution of monomer and CP 730-1 was added to it. A miniemulsion was formed by shearing at a speed setting of 6 (10,000 rpm) for 14 minutes. The pH of the miniemulsion was 5.0 and the particle size (mv) by light scattering (Microtrac) in 0.1% sodium dodecyl sulfate was 419 nm.

Polymerization was carried out in a 1-L jacketed reactor heated with circulating water and equipped with a nitrogen inlet, thermocouple and mechanical agitator. The reactor was charged with 240 g water and 4.2 g Lubrizol 2405 AMPS, purged with nitrogen and heated to 80°. At the start of the polymerization a mixture of 0.7 g sodium persulfate and 10 g of water was added to the reactor. The miniemulsion formed in the prior step was added over 111 minutes. Concurrently, a mixture of 0.7 g sodium persulfate and 35 g of water was added over 90 minutes. The contents of the reactor was held at 85-90° C. for one hour, cooled and filtered through a 100 mesh screen. The milky-white, low viscosity product had a pH of 5.3, a particle diameter of 187 nm, 44.3% NVM.

### Example 4

General procedure for using the aqueous compositions of the present invention as water-borne, adhesion enhancing primers for thermoplastic polyolefin panels.

Example 4 provides a comparison of Examples 2 and 3 and demonstrates that the oil-soluble initiator in Example 2 leads to a product with better adhesion than Example 3 with the water-soluble initiator.

The product of Examples 2 and 3 were reduced to 20% NVM by adding water. The substrate was a 2″×6″ thermoplastic polyolefin panel (Solvay Sequel 1440, lot 1661797, code 55454BH from Standard Plaque Inc., 17271 Francis St., Melvindale, Mich., USA, 48122). All tests were run in triplicate. Panels was wiped down with isopropanol and air dried. The diluted adhesion promoter dispersion in water was sprayed on the panel. The panel was dried under ambient conditions for ca. 3 min. and the panel was sprayed again. After drying at room temperature, the panels were sprayed with the topcoat.

The one-pack (1K) basecoat was Dupont 1K/1K basecoat code 872-DF716, clearcoat code RK-3939. The two-pack (2K) basecoat was Red Spot 2K/2K basecoat code 206LE20849 bom, clear coat code 379521654CC

The basecoat was sprayed at a pressure of 50 psi and the clearcoat was sprayed at a pressure of 45 psi. The 1K panels were cured at 170 F for 40 minutes. The 2K panels were cured at 250° F. for 40 minutes. The panels were then let stand for 7-10 days at ca 70° F./50% humidity before evaluations were done.

The cured panels were evaluated by testing the initial adhesion with a cross-hatched tape test in accordance with ASTM D3359B. Results are reported as the percent of coating retained on the substrate. Following evaluation of initial adhesion, the coated panels were placed on a Cleveland humidity cabinet. Adhesion after exposure to Cleveland humidity was conducted in accordance with ASTM D4585 (120° F.) and blistering of the coating systems was determined in accordance with ASTM D-714. The tape used for determining adhesion was Permacel 99.

Comparison of Examples 2 and 3 as a primer for a one-pack topcoat are shown below. The reported percents are the average of two readings.

| Adhesion | Initial | 24 hours | 48 | 72 | 168 | | |
|---|---|---|---|---|---|---|---|
| Promoter | Adhesion | humidity | hours | hours | hours | 216 hours | 336 hours |
| Example 2 | 100% | 100% 8D | 18% 8D | 12% 8D | 3% 8D | 3% 8D | 0% 8D |
| Example 3 | 95% | 0% 8D | 0% 8D | — | — | — | — |

Comparison of the adhesion imparted by Examples 2 and 3 when used as a primer for a two-pack topcoat are shown below. The latex made with the monomer-soluble initiator performed better. The reported percents are the average of two readings.

| Adhesion | Initial | 24 hours | 48 | 72 | 168 | | |
|---|---|---|---|---|---|---|---|
| Promoter | Adhesion | humidity | hours | hours | hours | 216 hours | 336 hours |
| Example 2 | 55% | 30% 8D | 47% 8D | 38% 8D | 72% 8D | 47% 8D | 35% 8D |
| Example 3 | 0% | 0% 8D | 0% 8D | — | — | — | — |

The invention has been described in detail with particular reference to preferred embodiments thereof, but it will be understood that variations and modifications can be effected within the spirit and scope of the invention.

We claim:

1. A process to produce an aqueous composition comprising shearing a mixture to produce a mini-emulsion and polymerizing said mini-emulsion in the presence of a monomer-soluble initiator to produce said aqueous composition; wherein said mixture comprises at least one adhesion promoter, at least one ethylenically unsaturated monomer, at least one surfactant, and water.

2. A process according to claim 1 wherein said adhesion promoter is dissolved in at least one ethylenically unsaturated monomer to form an adhesion promoter/monomer mixture, and said adhesion promoter/monomer mixture is then dispersed in an aqueous medium comprising surfactant and water to form the mixture.

3. A process according to claim 1 wherein said shearing is conducted using a high shearing device to form droplets ranging in size from about 50 to about 500 nanometers to form the mini-emulsion.

4. The process of claim 1 wherein said adhesion promoter comprises a polyolefin.

5. The process of claim 4 wherein said polyolefin is halogenated.

6. The process of claim 5 wherein said halogen is chlorine.

7. A process according to claim 1 wherein said adhesion promoter is one or more of maleated, chlorinated polyolefins or maleated polyolefins.

8. The process of claim 4 wherein said polyolefin is modified with a polyfunctional alcohol.

9. The process of claim 8 wherein said polyfunctional alcohol is selected from the group consisting of trimethylolethane, pentaerythritol, trimethylolpropane, 1,6-hexanediol, 1,4-cyclohexanediol, 1,2-propylene glycol, 1,4-cyclohexanedimethanol, 2,2,4-trimethyl-1,3-pentanediol, 2-ethyl-1,3-hexanediol, 2-butyl-2-ethyl-1,3-propanediol, diethylene glycol, triethylene glycol, polyethylene glycols, glycerol, polyester polyols, acrylic polyols, polyurethanepolyols, glucose, sucrose, 2-amino-1-propanol, ethanolamine, 1,3-propylene glycol, neopentyl glycol, 2,2-dibutyl-1,3-propanediol, 2-methyl-2-propyl-1,3-propanediol, 2,2-diethyl-1,3-propanediol, ethyleneglycol, 2-amino-2-methyl-1-propanol, tris(hydroxymethyl)methylamine, 2,2-dimethyl-3-amino-1-propanol, and combinations thereof.

10. A process according to claim 1 wherein the adhesion promoter portion of the aqueous composition represents about 0.5 to about 60 weight percent based on the total solids of the aqueous composition.

11. A process according to claim 1 wherein the adhesion promoter portion of the aqueous composition represents about 5 to about 40 weight percent based on the total solids of the aqueous composition.

12. A process according to claim 1 wherein the adhesion promoter portion of the aqueous composition represents about 10 to about 30 weight percent based on the total solids of the aqueous composition.

13. A process according to claim 1 wherein said ethylenically unsaturated monomer is one or more of styrenic monomers such as styrene, .alpha.-methyl styrene, vinyl naphthalene, vinyl toluene, chloromethyl styrene and the like; ethylenically unsaturated species such as, for example, methyl acrylate, acrylic acid, methacrylic acid, methyl methacrylate, ethyl acrylate, ethyl methacrylate, butyl acrylate, butyl methacrylate, isobutyl acrylate, isobutyl methacrylate, ethylhexyl acrylate, ethylhexyl methacrylate, octyl acrylate, octyl methacrylate, lauryl methacrylate, lauryl acrylate glycidyl methacrylate, carbodiimide methacrylate, alkyl crotonates, vinyl acetate, di-n-butyl maleate, di-octylmaleate, acetoacetoxyethyl methacrylate, diacetone acrylamide, acrylamide, methacrylamide, hydroxyethyl methacrylate, hydroxyethyl acrylate, and acrylonitrile and the like; or nitrogen containing monomers including t-butylaminoethyl methacrylate, dimethylaminoethyl methacrylate, diethylaminoethyl methacrylate, N,N′-dimethylaminopropyl methacrylamide, 2-t-butylaminoethyl methacrylate, N,N′-dimethylaminoethyl acrylate, N-(2-methacryloyloxy-ethyl)ethylene urea, methacrylamidoethylethylene urea and the like.

14. A process according to claim 1 wherein the polymer from the ethylenically unsaturated monomer represents about 40 to about 99 weight percent based on the total solids of the aqueous composition.

15. A process according to claim 1 wherein the polymer from the ethylenically unsaturated monomer represents about 60 to about 95 weight percent based on the total solids of the aqueous composition.

16. A process according to claim 1 wherein the polymer from the ethylenically unsaturated monomer represents about 80 to about 96 weight percent based on the total solids of the aqueous composition.

17. A process according to claim 1 wherein said surfactant is at least one selected from the group consisting of an anionic surfactant and a non-ionic surfactant.

18. A process according to claim 1 wherein said surfactant is one or more of alkali alkylsulfate, ammonium alkylsulfate, alkylsulfonic acid, fatty acid, oxyethylated alkylphenol, sulfosuccinates or derivatives.

19. A process according to claim 1 wherein said surfactant is at least one polymerizable surfactant.

20. A process according to claim 1 wherein said surfactant represents about 0.10 to about 10 weight percent based on the total solids of the aqueous composition.

21. A process according to claim 1 wherein said surfactant represents about 0.3 to 3 weight percent based on the total solids of the aqueous composition.

22. A process according to claim 1 wherein said initiator is one or more of 2,2-azobisisobutyronitrile, t-butylperoxy 2-ethylhexanoate, azo initiators such as AIBN, or ammonium carbonate, hydrogen peroxide, t-butylhydroperoxide, di-benzoyl peroxide, lauryl peroxide, di-t-butylperoxide, or benzoyl peroxide.

23. A process according to claim 1 wherein said mixture further comprises at least one co-stabilizer.

24. A process according to claim 23 wherein said co-stabilizer is one or more of hexadecane or hexadecanol.

25. An aqueous composition produced by the process of claim 1.

26. A coating comprising said aqueous composition of claim 1.

27. A coating composition comprising said aqueous composition of claim 26 and at least one additive selected from the group consisting of rheology agents, flow control agents, extenders, reactive coalescing aids, plasticizers, flatting agents, pigment wetting and dispersing agents, surfactants, ultraviolet (UV) absorbers, UV light stabilizers, tinting pigments, colorants, defoaming agents, antifoaming agents, anti-settling, anti-sag and bodying agents, anti-skinning agents, anti-flooding agents, anti-floating agents, biocides, fungicides, mildewcides, corrosion inhibitors, thickening agents, and coalescing agents.

28. The coating composition of claim 27, wherein the composition provides significant adhesion promoting characteristics in architectural coatings, maintenance coatings, industrial coatings, automotive coatings, textile coatings, inks, adhesives, or coatings for paper, wood, and plastics.
